(19) United States
(12) Patent Application Publication
(10) Pub. No.: US 2014/0198439 A1
(43) Pub. Date: Jul. 17, 2014

(54) COVER FOR AUDIO AND VIDEO INPUTS

(71) Applicants: David De Pietro, Lisbon, CT (US); Frederick De Pietro, Jr., Norwich, CT (US)

(72) Inventors: David De Pietro, Lisbon, CT (US); Frederick De Pietro, Jr., Norwich, CT (US)

(21) Appl. No.: 13/742,306

(22) Filed: Jan. 15, 2013

(51) Int. Cl. G06F 1/16

(52) U.S. Cl. CPC G06F 1/16
USPC 361/679.02

(57) ABSTRACT

A microphone or lens cover covers a microphone opening or the lens of a camera on a portable computer or mobile electronic device. The base of the cover is affixed to the electronic device, and the lid is movable to permit the microphone or lens to be exposed and used, or to be covered. The base holds the lid in place both when the lid is covering the microphone or lens, and when the lid is moved aside to permit the microphone or lens to be used. In either the open or closed position, the lid is held in place either by magnetic attraction, or self-adhesive vinyl, or by hook and loop fasteners, depending on the construction of the cover. The base of the cover is affixed to the electronic device by way of adhesive.

### FIELD

Covers for camera lenses and microphones used with computers and mobile communication and electronic devices.

### BACKGROUND

Presently there are over one billion internet-ready devices in the world and even more electronic devices that have a webcam or audio input to them. There has been an increased demand for privacy and security while these devices are on and active. The range of electronic devices that include microphones, cameras, or both is increasing. In addition to laptop computers and mobile phones, tablet computers, televisions, vehicles, eyeglasses, goggles, and watches can include microphones and/or cameras. There are also stand-alone microphones and cameras designed to operate with such electronic devices which, when connected to the electronic devices, raise the same privacy and security concerns.

There has been an increase in the use of spyware, malware and other surreptitious software that is implanted in these devices without the user's knowledge. This software can be made capable of accessing the devices' cameras and/or microphones, allowing images and sound to be transmitted to an unknown third party without the knowledge of the user. Audio and video images are being stolen from homes, businesses, government facilities and personal areas without the express consent of the end users.

At present, users have imperfect alternative ways to secure their webcams and microphones from such undesired intrusions and access. Anti-virus software is not always effective, as viruses and other malware are constantly being adapted specifically to avoid being detected. Users will sometimes apply a piece of tape or other adhesive, such as a removable adhesive-backed note, over the audio or video input in an effort to physically block sound or image transmission. While this may be somewhat effective, it can also damage the audio or video input by leaving adhesive behind when removed, or by scratching the video input when the blocking medium is applied and removed over and over again.

US Patent Application 20110058255 describes several types of image lens covers. One type of cover consists of a base and a cover, with the cover mounted to the base by way of a pin-hinge. Another type of cover consists of a horizontal hinge portion and a movable portion that blocks access to the camera lens and can be rotated about the horizontal hinge. In one embodiment of this, the movable portion can be secured in the closed position by way of a snap device. Another type of cover simply slides back and forth along the edge of the electronic device to cover and uncover the lens. Another type of cover hangs from hooks attached to the device; when on one hook the cover obscures the lens; when on another hook, the cover does not. Another type of cover mounts to the electronic device by way of a suction cup that is attached to a cord that is attached to the device. It relies on suction to stay in place over the lens, and then hangs by the cord when it is not being used. Another type of cover is made of plastic and mounts over the lens by way of a “Zip-Loc” type of closure.

There are problems with each of these covers. The pin-hinge and horizontal-hinge covers are expensive to manufacture and require close tolerances to operate properly. The sliding covers must fit the width of the particular electronic device and so must be manufactured in many different sizes. The hooked cover adds protuberances to the electronic device that can easily break, rendering the cover ineffective. The suction cup cover relies on suction to remain in place, and is at risk of detaching without notice. The “Zip-Loc” cover closure is difficult to apply and remove and is easily torn. In addition, none of these covers are intended to cover and/or muffle a microphone.

There is a need for an economical, effective lens and microphone cover that can be manufactured in large quantities at relatively low cost, with minimal size and configuration variations, that is easy to use and does not impede the operation of the electronic device to which it is attached.

### SUMMARY

In one embodiment, a lens or microphone cover device is constructed in the form of a base and a lid from a flexible magnetic material similar to that used in what are typically referred to as “refrigerator magnets.” The base consists of a rim with a centered opening sized to permit the lens or microphone of the electronic device to operate when the lens or microphone is centered on the base's opening. Adhesive is applied to one side of the base so that it adheres to the electronic device. The lid is sized to cover the opening and to extend beyond it so that when it is in place it overlaps with all or part of the rim of the base. Typically the magnetic material is constructed with multiple alternating magnetic poles oriented through the thickness of the material, so that the base is attracted to the lid when the lid is placed in a variety of positions.

In another embodiment, the magnetic lid includes additional material at approximately the center point of the lid. The additional material is sized and shaped so that it fits within the microphone or lens opening of the base.

In a further embodiment, the base opening is not centered so that the rim of the base is asymmetrical in at least one orientation.

In yet another embodiment, a lens or microphone cover device is constructed in the form of a base and a lid from a hook-and-loop material. The physical structure of the device is similar to that of the magnetic version. The base is constructed from either the hook or the loop portion of the material; the lid is correspondingly constructed from the loop or the hook portion. The base includes adhesive on the non-hook (or non-loop) side so that it adheres to the electronic device.

In another embodiment, a lens or microphone cover device is constructed in the form of a base and a lid from self-adhesive vinyl material. The physical structure of the device is similar to that of the magnetic version, with both the base and the lid constructed from self-adhesive vinyl material. In this embodiment, the properties of the self-adhesive vinyl material allow it to adhere to the electronic device without any additional adhesive; alternatively, adhesive could be applied to the back of the base to further secure it to the device. The self-adhesive properties of the self-adhesive vinyl allow the lid of the cover to adhere to the base, and allow it to be removed and replaced many times.

In all cases, the cover will restrict the ability of a camera lens to transmit images, and will inhibit the ability of a microphone to transmit sound.

### BRIEF DESCRIPTION OF THE DRAWINGS

FIG. 1A illustrates one embodiment of the cover device. The base and lid are circular, and the base's microphone or lens opening is circular and centered.

FIG. 1B illustrates one embodiment of the cover device. The base and lid are circular, and the base's microphone or lens opening is circular and centered. One side of the lid includes a raised section that is sized to nest within the base's microphone or lens opening.

FIG. 2 illustrates one embodiment of the cover device. The base and lid are circular, and the base's microphone or lens opening is circular and placed off-center.

FIG. 3 illustrates one embodiment of the cover device. The base and lid are square, and the base's microphone or lens opening is circular and centered.

FIG. 4 illustrates one embodiment of the cover device. The base is rectangular, the base's microphone or lens opening is square and off-center, and the lid is square.

FIG. 5 illustrates one embodiment of the cover device where the lid has been moved aside to uncover the base's microphone or lens opening.

FIG. 6A illustrates a side view of the embodiment shown in FIG. 1A where the cover device is constructed from flexible magnet material.

FIG. 6B illustrates a side view of the embodiment shown in FIG. 1B where the cover device is constructed from flexible magnet material.

FIG. 7 illustrates a side view of the embodiment shown in FIG. 2 where the cover device is constructed from flexible magnet material.

FIG. 8 illustrates a side view of the embodiment shown in FIGS. 1 and 3 where the cover device is constructed from hook-and-loop material.

FIG. 9A illustrates, in perspective, the embodiment shown in FIGS. 1 and 6 when used on a laptop computer to cover a webcam lens.

FIG. 9B illustrates, in perspective, the embodiment shown in FIG. 5 when used on a laptop computer to uncover a webcam lens.

FIG. 10A illustrates, in perspective, the embodiment shown in FIGS. 1A and 6A when used on a mobile device to cover a camera lens.

FIG. 10B illustrates, in perspective, the embodiment shown in FIG. 5 when used on a mobile device to uncover a camera lens.

FIG. 11A illustrates, in perspective, the embodiment shown in FIGS. 1A and 6A when used on a laptop computer to cover a microphone.

FIG. 11B illustrates, in perspective, the embodiment shown in FIG. 5 when used on a laptop computer to uncover a microphone.

### DETAILED DESCRIPTION

The embodiments described herein provide devices that allow users to cover and uncover microphones and camera lenses connected to or integrated into computers, mobile communications devices, and other electronic devices, including laptops, tablet computers, personal digital assistants, smartphones, mobile telephones, televisions, wi-fi enabled cameras, eyeglasses, goggles, and watches, and the like. The devices of the present invention may be fabricated in mass quantities from flexible magnetic material such as that commonly used in so-called “refrigerator magnets.” They may also be fabricated from self-adhesive vinyl. These materials have the advantage of being relatively inexpensive. They are easily cut or punched into a variety of shapes. Alternatively, the devices of the present invention may be fabricated from rigid magnetic materials, as well as so-called “hook and loop” material. In the preferred embodiment, adhesive is applied to the back side of the cover's base to permit it to be attached to a device; in the case of self-adhesive vinyl material whether or not the adhesive material is applied will depend on the properties of the device to which the cover is to be attached; in some cases, the adhesive qualities of the self-adhesive vinyl material may provide the degree of adhesion necessary so that the base remains in place through repeated uses. In other cases, additional adhesive may be necessary to keep the base in place during use. The base defines an opening through which the device's camera or microphone can operate when the cover's lid is removed. The base is attached to the electronic device in such a way so that the device's microphone or camera lens is at the relative center of the opening defined by the base. To cover the device's camera or microphone, the lid is put in place. Where the base and lid are made from flexible magnetic material, the lid is held in place against the base by way of magnetic attraction. Where the base and lid are made from self-adhesive vinyl material, the properties of the material hold the lid to the base. Where the base and lid are made from complementary hook-and-loop material, the lid is held in place against the base by way of the actions of the hooks against the loops. In all of these cases, the lid may be removed to uncover the opening in the base, permitting the device's lens or microphone to be accessed and used. In all of these cases, the lid may be temporarily stored by attaching it to the edge of the rim of the base. This permits the user to keep track of the location of the lid when it is not covering the opening in the base, and further permits the user to easily replace the lid over the base when access to the lens or microphone is no longer required.

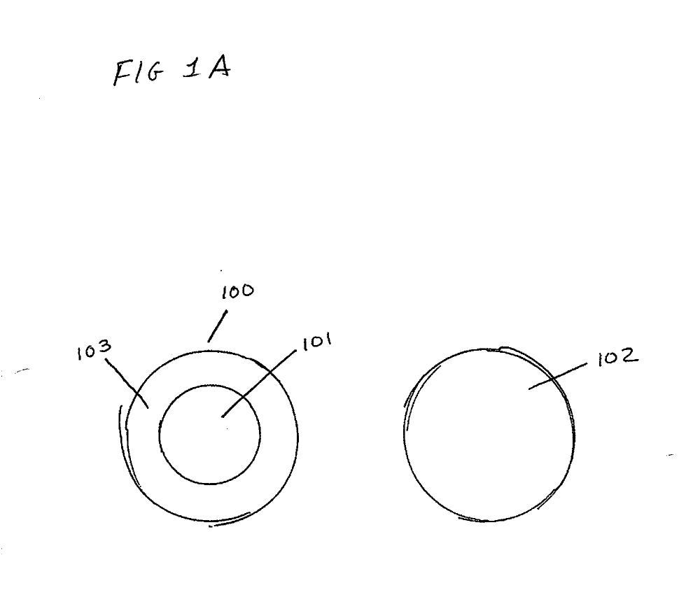

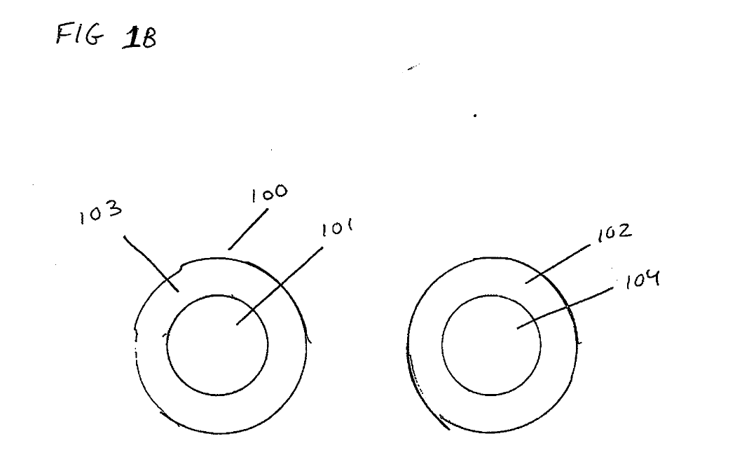

FIG. 1A illustrates one embodiment of the cover of the present invention. A base 100 is formed from a suitable material as described herein; in this embodiment, a flexible magnetic material such as that used in so-called “refrigerator magnets” commonly distributed by advertisers to customers. Alternative materials are rigid magnets, self-adhesive vinyl, as well as complementary pieces of “hook-and-loop” material. In this embodiment, the base 100 is circular. Those skilled in the art will recognize that the base may take any number of shapes, such as square, oval, star, pentagon, and the like. A lid 102 is approximately the same diameter and shape as the base. In the case of a cover fabricated from magnetic or hook-and-loop material, adhesive, typically of a semi-permanent nature and covered until use by a “peel-off” covering, is applied to the rear side of base 100. An opening 101 is formed in the center of said base, defining a rim 103 and sized so that when the base is affixed to an electronic device with the lens or microphone approximately centered on said opening, the base does not interfere with or impede the operation of the lens or microphone. When the lid 102 is in use, the user positions it over the base 100 and magnetic attraction holds the two pieces in place.

FIG. 1B illustrates another embodiment of the cover of the present invention. In this embodiment, the lid 102 includes a raised section 104 that is sized to fit within the opening 101 of the base 100. When the lid is put in place over the base, the raised section nests within the opening of the base and acts as a further restriction against side-to-side movement of the lid. Depending on the application, said raised section can be dimensioned so that it fits in to a recessed portion of the electronic device, such as a recessed camera lens or an opening for a microphone. When used as a microphone cover, the raised section 104 of lid 102 also restricts the transmission of sound waves to the microphone sensor, particularly where raised section 104 is sized so that it fits within an opening in the device that serves as a pathway for sound waves to reach the microphone sensor. In all other respects, the cover of FIG. 1b is applied to the device and used in the same manner as is the cover of FIG. 1a.

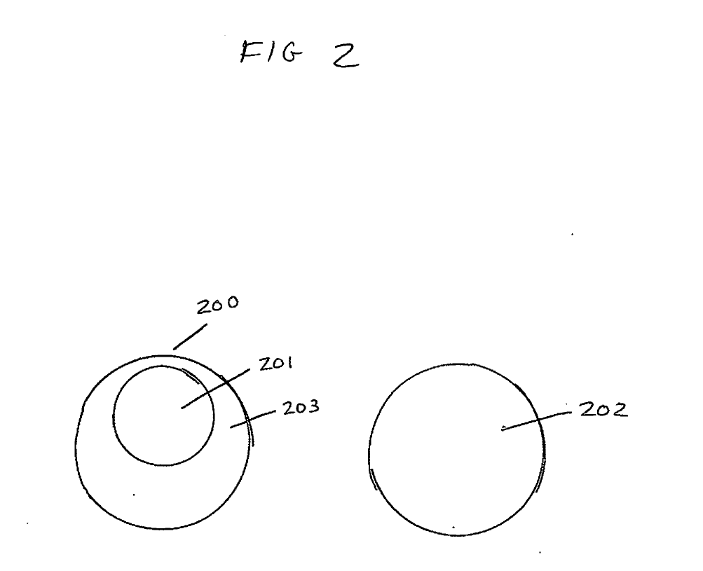

FIG. 2 illustrates another embodiment of the cover of the present invention. In this embodiment, base 200 is constructed in such a way that the opening 201 is not centered. This permits the cover to be used on devices where the lens or microphone to be covered is adjacent to the edge of the device or to some aspect of the device that the user does not want to cover, such as a flash, switch, latch, or the like. The base 200 is affixed to the device in such a way so the narrowest portion of the rime 203 defined by the opening 201 is placed between the lens or microphone and the feature that the user does not want to obstruct. In the case of a cover fabricated from magnetic or hook-and-loop material, adhesive, typically of a semi-permanent nature and covered until use by a “peel-off” covering, is applied to the rear side of base 200. A lid 202 is approximately the same diameter as the base. Adhesive may also be applied to the rear side of base 200 when the cover is fabricated from self-adhesive vinyl; alternatively, depending on the surface to which the cover is to be attached, the natural properties of the vinyl may cause it to adhere satisfactorily to the device. When the lid 202 is in use, the user positions it over the base 200 and, where the cover is constructed of magnetic materials, magnetic attraction holds the two pieces in place. Where the cover is constructed of complementary pieces of “hook-and-loop” material, the hooks engage the loops and hold the two pieces of the cover in place. Where the cover is constructed of self-adhesive vinyl material, the properties of the material will hold the two pieces of the cover in place.

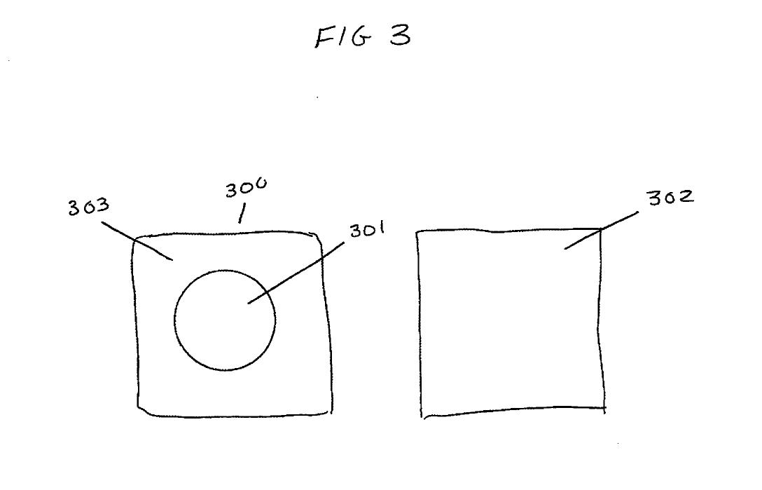

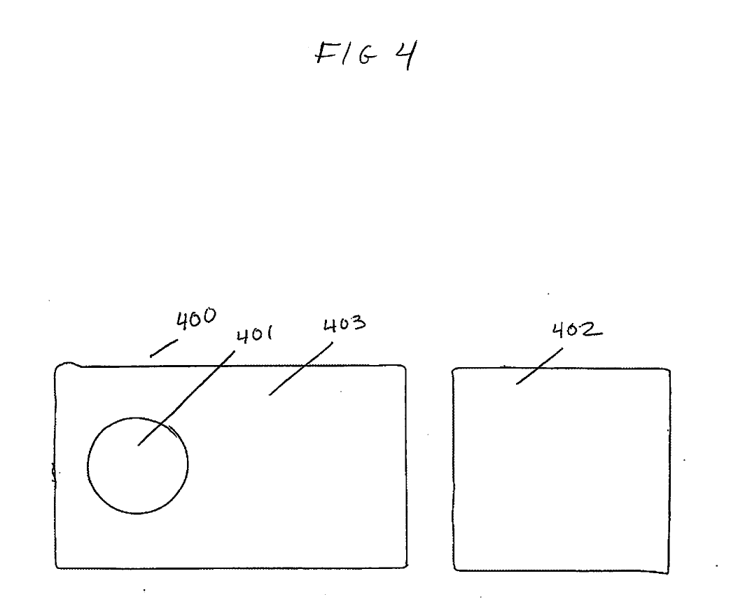

FIG. 3 illustrates another embodiment of the cover of the present invention. In this embodiment, the base 300 is approximately square-shaped. The opening 301 is circular and is located at the approximate centerpoint of the base. The lid 302 is also approximately square-shaped, sized to correspond with the size of the base 300. In the case of a cover fabricated from magnetic or hook-and-loop material, adhesive, typically of a semi-permanent nature and covered until use by a “peel-off” covering, is applied to the rear side of base 300. Those skilled in the art will appreciate that the opening 301 may be located off-center as described in FIG. 2. In addition, lid 302 may be constructed with the added raised section described in FIG. 1b.

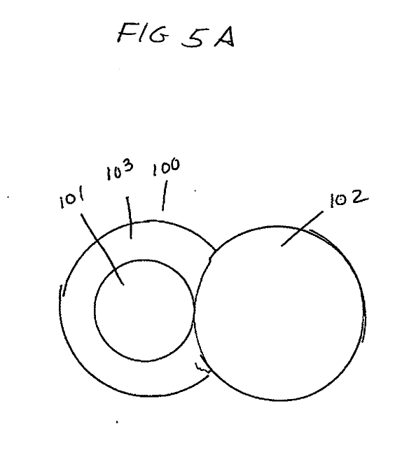

FIG. 4 illustrates another embodiment of the cover of the present invention. In this embodiment, the base 400 is approximately rectangularly-shaped. The opening 401 is circular and is located to one side of the base 400, leaving a majority of the material of the base 400 to one side of the opening 401. The lid 402 is approximately square-shaped and is sized so that it covers opening 401 when put in place and is approximately the same size as the narrower dimension of the rectangularly-shaped base 400. In the case of a cover fabricated from magnetic or hook-and-loop material, adhesive, typically of a semi-permanent nature and covered until use by a “peel-off” covering, is applied to the rear side of base 400. Adhesive can also be used when the cover is fabricated from self-adhesive vinyl. When the lid 402 is in use, the user positions it over the base 400 over opening 401 and magnetic attraction holds the two pieces in place. When the user wishes to uncover opening 401, the user may slide lid 402 to the side of base 400 away from opening 401, where magnetic attraction will hold it in place. Those skilled in the art will appreciate that the embodiment shown in FIG. 4 is also functional when the cover is constructed of complementary pieces of hook-and-loop material or self-adhesive vinyl.

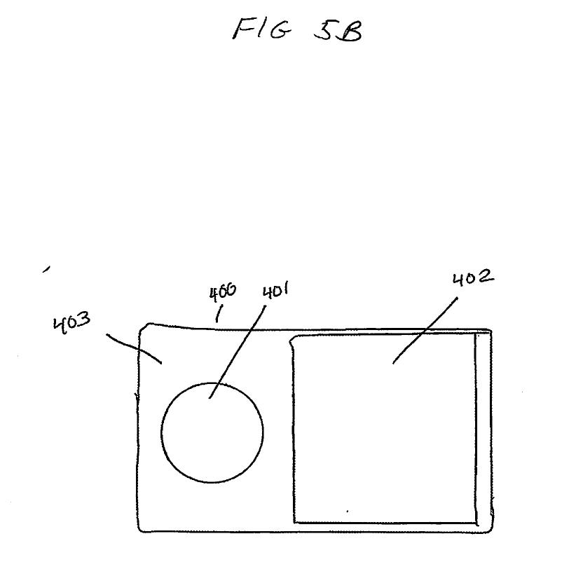

FIG. 5A illustrates the embodiment of the cover of the present invention described in FIG. 1, with the cover 102 in the open and stored position, permitting access to opening 101. Where the cover is constructed of magnetic material, magnetic attraction between the cover 102 and the rim 103 of base 100 holds the cover in place while the user enjoys access to the device's microphone or lens. Those skilled in the art will appreciate that the feature illustrated in FIG. 5a is also functional when the cover is constructed of self-adhesive vinyl as well as complementary pieces of hook-and-loop material.

FIG. 5B illustrates the embodiment of the cover of the present invention described in FIG. 4, with the cover 402 in the open and stored position, permitting access to opening 401. Where the cover is constructed of flexible magnetic material, magnetic attraction between the cover 402 and the rim 103 of base 400 holds the cover in place while the user enjoys access to the device's microphone or lens. Those skilled in the art will appreciate that the feature illustrated in FIG. 5b is also functional when the cover is constructed of self-adhesive vinyl as well as complementary pieces of hook-and-loop material.

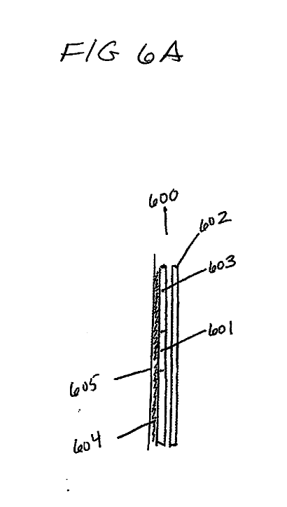

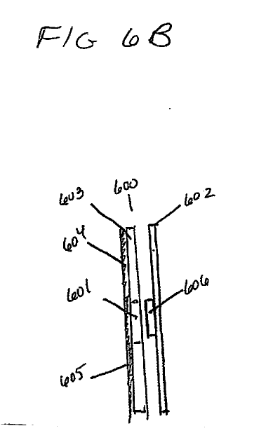

FIG. 6A illustrates a side view of the cover of the present invention described in FIG. 1a, when magnetic materials are used to construct the cover and when the lid is in place. Magnetic attraction holds base 600 and lid 602 together, while lid 602 obstructs opening 601. Adhesive 604 is applied to the rim 603 of base 600 and is typically covered until use by peel-off-material 605.

FIG. 6B illustrates a side view of the cover of the present invention described in FIG. 1b, when magnetic materials are used to construct the cover and when the lid is in place. Magnetic attraction holds base 600 and lid 602 together, while lid 602 obstructs opening 601. Raised section 606 nests within opening 601 and helps prevent lid 602 from sliding back and forth across base 600. Adhesive 604 is applied to the rim 603 of base 600 and is typically covered until use by peel-off-material 605.

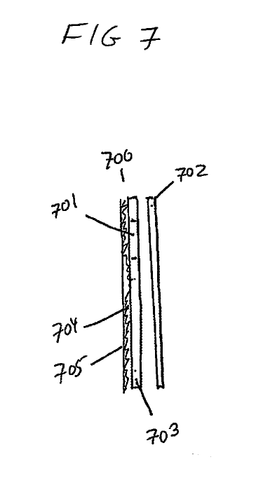

FIG. 7 illustrates a side view of the cover of the present invention described in FIG. 2, when magnetic materials are used to construct the cover and when the lid is in place. Magnetic attraction holds base 700 and lid 702 together, while lid 702 obstructs off-center opening 701. Adhesive 704 is applied to the rim 703 of base 700 and is typically covered until use by peel-off-material 705.

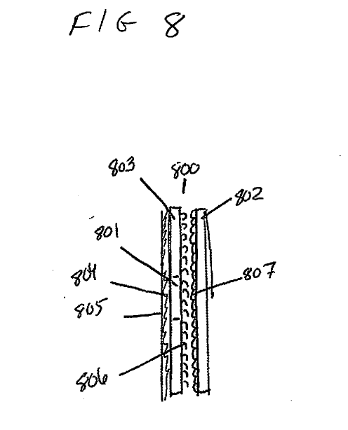

FIG. 8 illustrates a side view of the cover of the present invention described in FIG. 1a, when complementary hook-and-loop materials are used to construct the cover and when the lid is in place. The physical interaction between the hooks 806 and the loops 807 holds base 800 and lid 802 together, while lid 802 obstructs opening 801. Adhesive 804 is applied to the rim 803 of base 800 and is typically covered until use by peel-off-material 805.

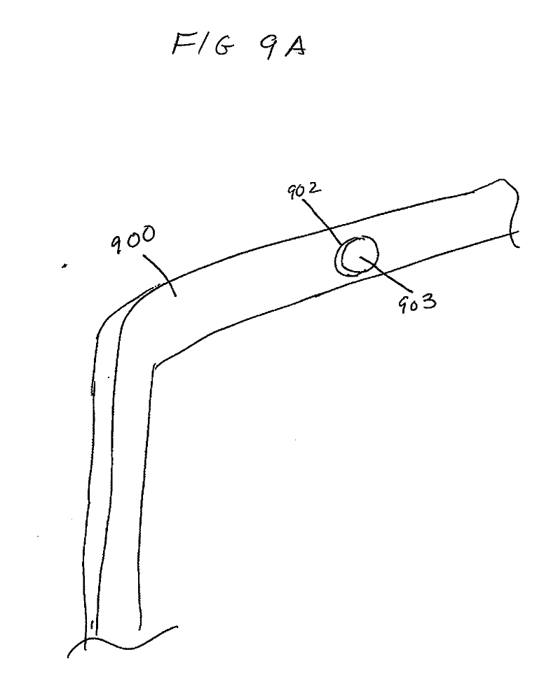

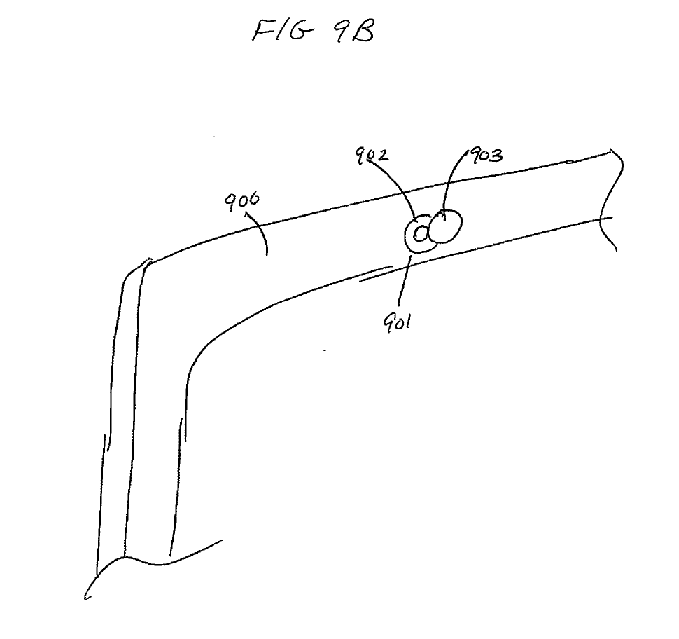

FIG. 9A illustrates the cover of the present invention when in use to cover the camera lens of a laptop computer 900. The base 902 of the cover 901 is affixed over the lens of the computer 900, and the lid 903 of cover 901 is moved so that it covers the opening of base 902, obscuring the lens of computer 900, where either magnetic attraction (where magnetic materials are used to make the cover), self-adhesion (where self-adhesive vinyl material is used to make the cover) or hooks and loops (where hook-and-loop material is used to make the cover) hold the lid in place.

FIG. 9B illustrates the cover of the present invention when in use to allow a camera lens of a laptop computer 900 to be used. The base 902 of the cover 901 is affixed over the lens of the computer 900, and the lid 903 of cover 901 is moved to one side of base 902 to permit access to the camera lens of computer 900, where either magnetic attraction (where magnetic materials are used to make the cover), self-adhesion (where self-adhesive vinyl material is used to make the cover), or hooks and loops (where hook-and-loop material is used to make the cover) hold the lid in place.

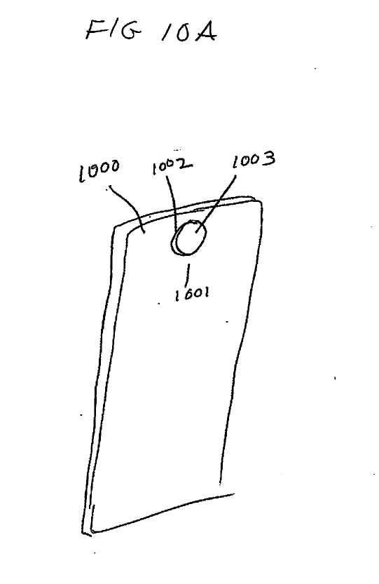

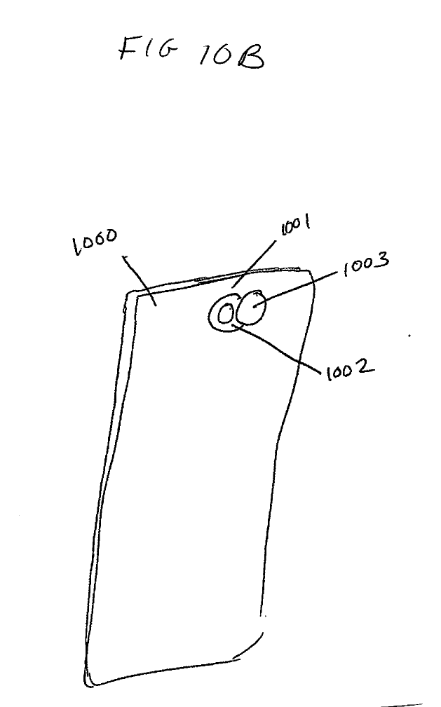

FIG. 10A illustrates the cover of the present invention when in used to allow a camera lens of a mobile electronic device 1000 to be used. The base 1002 of the cover 1001 is affixed over the lens of the mobile electronic device 1000, and the lid 1003 of cover 1001 is moved so that it covers the opening of base 1002, obscuring the lens of mobile electronic device 1000, where either magnetic attraction (where magnetic materials are used to make the cover) self-adhesion (where self-adhesive vinyl material is used to make the cover), or hooks and loops (where hook-and-loop material is used to make the cover) hold the lid in place.

FIG. 10B illustrates the cover of the present invention when in use to allow a camera lens of a mobile electronic device 1000 to be used. The base 1002 of the cover 1001 is affixed over the lens of the mobile electronic device 1000, and the lid 1003 of cover 1001 is moved to one side of base 1002 to permit access to the camera lens of mobile electronic device 1000, where either magnetic attraction (where magnetic materials are used to make the cover), self-adhesion (where self-adhesive vinyl material is used to make the cover), or hooks and loops (where hook-and-loop material is used to make the cover) hold the lid in place.

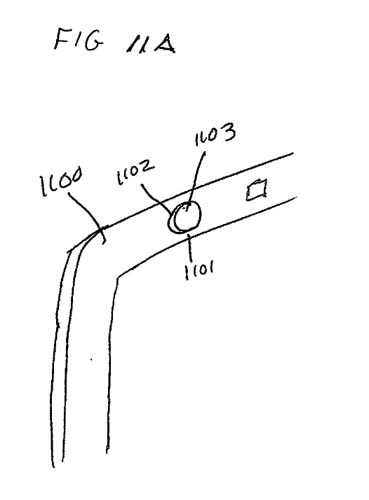

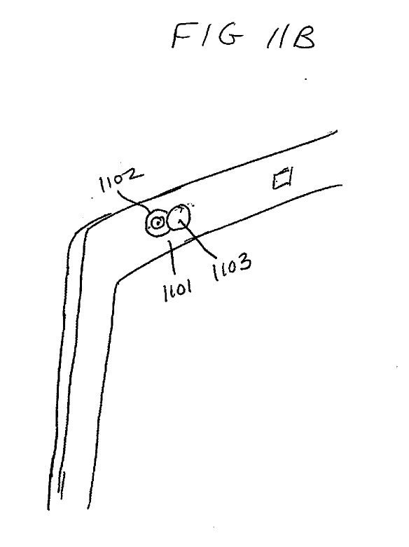

FIG. 11A illustrates the cover of the present invention when in used to allow a microphone of a laptop computer 1100 to be used. The base 1102 of the cover 1101 is affixed over the opening of the microphone of laptop computer 1100, and the lid 1103 of cover 1101 is moved so that it covers the opening of base 1102, obscuring the opening of the microphone of laptop computer 1100, where either magnetic attraction (where magnetic materials are used to make the cover), self-adhesion (where self-adhesive vinyl material is used to make the cover), or hooks and loops (where hook-and-loop material is used to make the cover) hold the lid in place.

FIG. 11B illustrates the cover of the present invention when in use to allow a microphone of a laptop computer 1100 to be used. The base 1102 of the cover 1101 is affixed over the opening of the microphone of laptop computer 1100, and the lid 1103 of cover 1101 is moved to one side of base 1102 to permit access to the microphone of laptop computer 1100, where either magnetic attraction (where magnetic materials are used to make the cover), self-adhesion (where self-adhesive vinyl material is used to make the cover), or hooks and loops (where hook-and-loop material is used to make the cover) hold the lid in place.

As is apparent, the cover of the present invention may be constructed in a variety of shapes and sizes, both as required to cover the lens and microphone openings of the devices to which the covers are to be attached, and as may be desired to provide space for the lid of the cover to be stored by the user when the microphone or lens is exposed. Alternatively, the cover may include additional material fabricated from the same material as the base that can also be attached to the electronic device and used to store the lid when the lid is not being used to cover the microphone or lens. Generally speaking, the space surrounding a camera lens on a mobile electronic device is less than that surrounding a camera lens on a laptop computer, thus requiring a smaller cover be used on a mobile electronic device than on a laptop computer. This is also true for other devices, such as watches, eyeglasses, and goggles. The size of the opening of the cover is dictated by the size of the microphone opening or camera lens to be covered. Generally, however, camera lenses are larger than microphone openings, and range from approximately “pinhole” size to as much as 5 inches across. The actual size used will vary depending on the dimensions and layout of the device for which the cover is intended to be used.

While various embodiments have been described in the preceding discussion, it should be understood that many other embodiments fall within the scope of the attached claims.

I claim:

1. A cover for audio and video inputs comprising:
a base portion sized to substantially cover a lens or microphone opening formed within an electronic device;
an attaching means to permit said base portion to be affixed to said electronic device;
an opening disposed within said base portion that forms a rim portion of said base portion;
a lid portion sized to substantially cover said base portion
where said base portion and said lid portion are fabricated of materials that are mutually attracted to each other; and
where said opening is of a size to permit said lens or microphone to operate when said lid portion is not in place.

2. A cover for audio and video inputs as recited in claim 1 where said base portion and said lid portion are fabricated from ferromagnetic material.

3. A cover for audio and video inputs as recited in claim 1 where said base portion and said lid portion are fabricated from complementary pieces of hook-and-loop material.

4. A cover for audio and video inputs as recited in claim 1 where said base portion and said lid portion are fabricated from self-adhesive vinyl material.

5. A cover for audio and video inputs as recited in claim 1 where said opening is disposed at the centerpoint of said base portion.

6. A cover for audio and video inputs as recited in claim 1 where said opening is disposed at a point other than the centerpoint of said base portion.

7. A cover for audio and video inputs as recited in claim 1 where said attachment means comprises an adhesive.

8. A cover for audio and video inputs as recited in claim 1 where said lid portion comprises a raised element designed to fit within said opening disposed within said base portion.

9. A cover for audio and video inputs as recited in claim 2 where said rim portion is of sufficient size to permit said lid portion to adhere to said rim portion while allowing access to said opening.

10. A cover for audio and video inputs as recited in claim 3 where said rim portion is of sufficient size to permit said lid portion to adhere to said rim portion while allowing access to said opening.

11. A cover for audio and video inputs as recited in claim 8 where said raised element is sized to fit within a recess or opening of said electronic device.

12. A cover for audio and video inputs as recited in claim 1 further comprising:
additional material fabricated from the same material as said base portion;
an attaching means to permit such additional material to be affixed to said electronic device;
where such additional material is sized such that said lid portion can be affixed to said base portion.
